(19) United States
(12) Patent Application Publication
(10) Pub. No.: US 2022/0343498 A1
(43) Pub. Date: Oct. 27, 2022

(54) SYSTEMS AND METHODS FOR IDENTIFYING AN X-RAY IMAGE THAT INCLUDES AN INSTANCE OF A VISUAL CHARACTERISTIC, AND DISPLAYING THE X-RAY IMAGE AND AN INDICATOR THAT CORRESPONDS TO THE INSTANCE OF THE VISUAL CHARACTERISTIC

(71) Applicant: Dentuit, Inc., Baltimore, MD (US)

(72) Inventor: Daniel Dongsung Lee, Ellicott CIty, MD (US)

(21) Appl. No.: 17/723,442

(22) Filed: Apr. 18, 2022

Related U.S. Application Data
(60) Provisional application No. 63/177,952, filed on Apr. 21, 2021.

(51) Int. Cl. G06T 7/00; G06T 7/70

(52) U.S. Cl. CPC G06T 7/0012; G06T 7/70; G06T 2207/10116; G06T 2207/20081; G06T 2207/30036

(57) ABSTRACT

A computer-implemented method uses one or more machine learning models to identify, within an image, an x-ray image showing evidence of an area of concern and displays the x-ray image and an indicator showing the location of the area of concern. The one or more machine learning models predict respective locations within an image of one or more first x-ray images, and predict an instance of a type of visual characteristic in a second x-ray image among the first x-ray images. A pre-defined visual indicator that corresponds with the instance of the type of visual characteristic is generated. The second x-ray image and the pre-defined visual indicator are displayed.

### CROSS-REFERENCE TO RELATED APPLICATIONS

This application claims the benefit of U.S. Provisional Patent Application No. 63/177,952, filed on Apr. 21, 2021, which is hereby incorporated by reference in its entirety.

### TECHNICAL FIELD

This specification relates generally to processing and display of images, and more particularly to systems and methods for identifying an x-ray image that includes an instance of a visual characteristic, and displaying the x-ray image and an indicator that corresponds to the instance of the visual characteristic.

### BACKGROUND

X-ray technology is commonly used by dentists to diagnose a variety of medical conditions. For example, a dentist may obtain x-ray images of a patient's teeth and examine the x-ray images to identify any areas of concern. Many dental offices use x-ray imaging software that allows a dentist to view one or more x-ray images of the patient's teeth on a display device while the patient is present. This type of software enables the dentist to view the x-ray images and identify potential areas of concern that may represent dental issues, and then to move back and forth between the displayed x-ray images and the patient in order to determine the severity of the identified dental issues.

### SUMMARY

Existing dental imaging software allows a dentist to view multiple x-ray images simultaneously on a display device. However, existing dental imaging software does not perform any analysis of the x-ray images to aid the dentist in identifying areas of concern, such as the location of a caries. The dentist must rely on his or her own expertise to analyze the x-ray images and diagnose any problems that may be present.

In accordance with an embodiment, one or more machine learning models are used to examine an image (for example, an image displayed on a dentist's computer screen) and predict the locations of one or more x-ray images within the image. The machine learning model(s) further analyzes the identified x-ray images and predicts the locations of one or more areas of concern. For example, a machine learning model may examine one or more x- ray images of a patient's teeth and identify a location in a selected x-ray image where evidence of a caries is present. The selected x-ray image and an indicator showing the location of the evidence of the caries may be displayed on a display device to enable the dentist rapidly focus on the area of concern. It is understood that, in some embodiments, the machine learning model(s) for locating x-rays images within the image may be different that one or more of the machine learning model(s) for identifying a location(s) of evidence of one or more types of caries.

In accordance with an embodiment, a computer-implemented method is disclosed. Respective locations within an image of one or more first x-ray images are predicted, and an instance of a type of visual characteristic in a second x-ray image among the first x-ray images is predicted. For example, the visual characteristic may include visual information in an x-ray image that shows evidence of a caries. A pre-defined visual indicator that corresponds with the instance of the type of visual characteristic is generated. The second x- ray image and the pre-defined visual indicator are displayed on a display device.

In one embodiment, the step of predicting an instance of a type of visual characteristic in a second x-ray image occurs on a computing device displaying the one or more first x-ray images.

In another embodiment, the step of generating the pre-defined visual indicator includes feeding machine learning input based at least on a portion of a screenshot of the second x-ray image into one or more machine learning models implemented on the computing device displaying the one or more first x-ray images, receiving, at the computing device, machine learning output, and generating the pre-defined visual indicator based on the machine learning output.

In another embodiment, the one or more machine learning models are trained according to training data comprising a plurality of human-generated indications of visual characteristics in x-ray images and confidence level scores each representing a level of confidence in a corresponding human-generated indication. In some embodiments, semantic segmentation is deployed to determine one or more masks to be displayed.

In another embodiment, the image includes the one or more first x-ray images. The image is generated by an independent first software application.

In another embodiment, the step of predicting an instance of a type of visual characteristic in a second x-ray image and generating a pre-defined visual indicator occur separately from the first software application.

In another embodiment, the image includes the one or more first x-ray images. The step of predicting an instance of a type of visual characteristic in a second x-ray image and generating a pre-defined visual indicator further occur while the first software application displays the image.

In another embodiment, at least one of the one or more first x-ray images includes at least an x-ray of at least one tooth.

In another embodiment, the instance of a type of visual characteristic comprises visual evidence of a type of caries.

In another embodiment, in response to the prediction of the instance of a type of visual characteristic, an indicator overlay is generated based on the pre-defined visual indicator. An overlay image is generated based on the screenshot that includes a least a portion of a display of the second x-ray image, the overlay image further includes the indicator overlay displayed with respect to a location of the instance of the type of visual characteristic.

In accordance with another embodiment, a device includes a memory storing computer program instructions, and a processor configured to execute the computer program instructions. The computer program instructions, when executed on the processor, cause the processor to perform operations including predicting respective locations within an image of one or more first x-ray images, predicting an instance of a type of visual characteristic in a second x-ray image identified among the one or more first x-ray images, and generating a pre-defined visual indicator that corresponds with the instance of the type of visual characteristic.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows functional components of a computer in accordance with an embodiment;

FIG. 3A is a flowchart of a method in accordance with an embodiment;

FIG. 3B is a flowchart of a method in accordance with another embodiment;

FIG. 4 shows a display device and an image that includes a plurality of x-ray images displayed thereon in accordance with an embodiment;

FIG. 5 shows a screenshot of the image of FIG. 4 displayed on a display device and two indicators indicating respective x-ray images in accordance with an embodiment;

FIGS. 6A-6B show first and second masks corresponding to an x-ray image in accordance with an embodiment;

FIG. 6C shows a mask corresponding to an x-ray image in accordance with another embodiment;

FIG. 7 shows a screenshot and a selected x-ray image displayed on a display device in accordance with an embodiment;

FIG. 8 shows a screenshot, a selected x-ray image, and first and second masks displayed on a display device in accordance with an embodiment;

FIG. 9 shows an x-ray image displayed on a display device in accordance with an embodiment;

FIG. 10 shows an x-ray image and first and second masks displayed on a display device in accordance with an embodiment; and

FIG. 11 shows components of an exemplary computer in accordance with an embodiment.

### DETAILED DESCRIPTION

A computer-implemented method uses one or more machine learning models to identify, within an image, an x-ray image showing evidence of an area of concern and displays the x- ray image and an indicator showing the location of the area of concern. More specifically, the one or more machine learning models predict respective locations within an image of one or more first x-ray images, and predict an instance of a type of visual characteristic in a second x-ray image among the first x-ray images. For example, the first x-ray images may be x-ray images of a patient's teeth, and the type of visual characteristic may be image data showing evidence of a particular type of caries in the patient's teeth. A pre-defined visual indicator that corresponds with the instance of the type of visual characteristic is generated. For example, the pre-defined visual indicator may be a mask with a pre-defined visual characteristic such as: a bounding box shape or color pattern showing the location in the second x-ray image of the evidence of the caries. The second x-ray image and the pre- defined visual indicator are displayed on a display device.

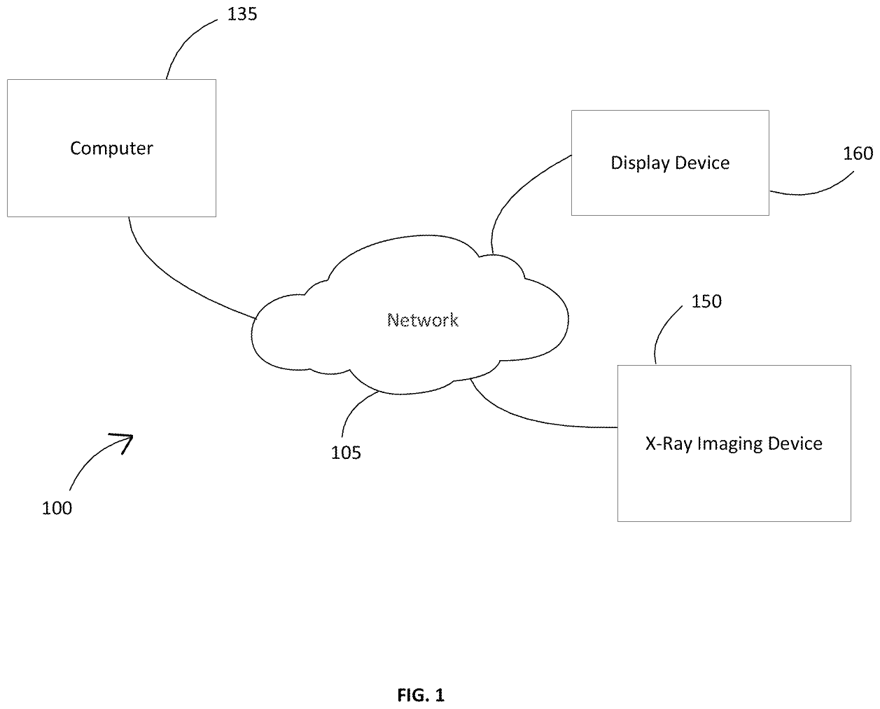

FIG. 1 shows a communication system in accordance with an embodiment. Communication system 100 includes a network 105, a computer 135, a display device 160, and an X-ray imaging device 150.

Network 100 may include any communications network adapted to transmit data. Network 100 may include the Internet, a local-area network (LAN), a wide-area network (WAN), an Ethernet, a Fiber channel network, a wireless network, or other type of network. Network 100 may include a combination of different types of networks.

X-ray imaging device 150 is a device adapted to irradiate a selected part of a patient's body with x-ray radiation and capture one or more x-ray images of the selected body part. In one embodiment, X-ray imaging device 150 is adapted to irradiate a patient's jaw and mouth with x-ray radiation and to capture x-ray images of the patient's teeth. X-ray imaging device 150 may provide x-ray images to computer 135 for processing and analysis and/or to display device 160 for display.

Computer 135 may be any processing device such as a personal computer, a laptop computer, a tablet device, a workstation, etc. In one embodiment, computer 135 includes at least one processor (such as a central processing unit, or CPU), a memory, and an operating system, and is adapted to run one or more software programs or applications. Computer 135 is linked to x-ray imaging device 150 and display device 160 via network 105.

Display device 160 includes a display screen adapted to display images. For example, display device 160 may be a standard computer display screen.

In one embodiment, some or all of x-ray imaging device 150, computer 135, display device 160, and network 105 are located in a dental office. While only a single computer is shown in FIG. 1, communication system 100 may include a plurality of computers. For example, multiple computers may be located at different locations within a dental office; each computer may be linked to network 105.

While in the illustrative embodiment of FIG. 1, display device 160 is linked to computer 135 via network 105, in another embodiment, display device 160 is linked directly to computer 135.

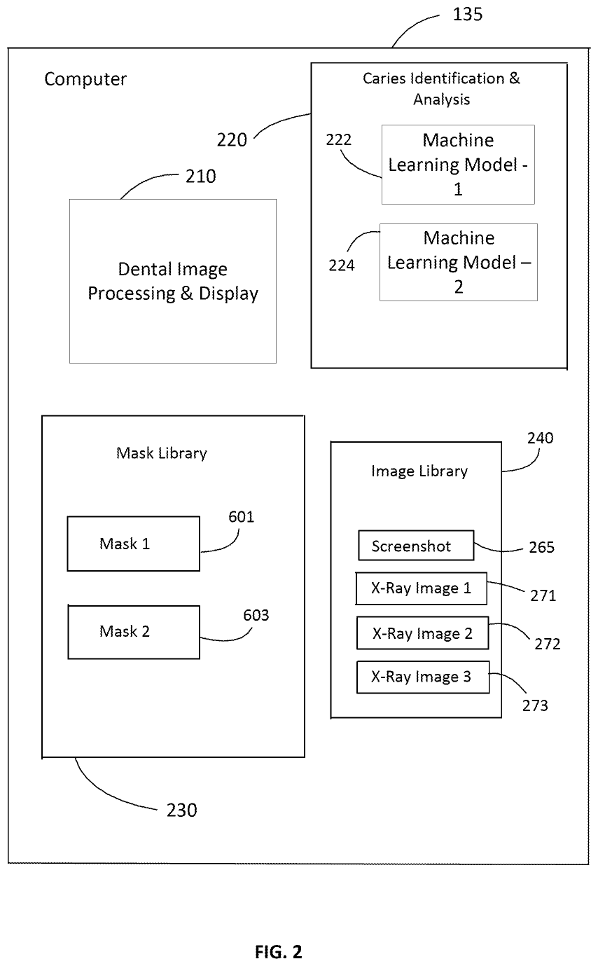

FIG. 2 shows functional components of computer 135 in accordance with an embodiment. Computer 135 includes a dental image processing & display 210, a caries identification & analysis 220, a mask library 230, and an image library 240.

Dental image processing & display 210 is a software application adapted to receive images from X-ray imaging device 150 and display the images on display device 160. In one embodiment, dental image processing & display 210 may be any software application commonly used by dental offices to process and display x-ray images of patients' teeth on a display screen for viewing and analysis. Dental imaging software applications are well known. Typically, after x-ray images of a patient's teeth are generated by X-ray imaging device 150, dental image processing & display 210 receives the x-ray images from X-ray imaging device 150 and displays, on display device 160, a single x-ray image or multiple x- ray images showing the condition of the patient's teeth. The dentist may examine the x-ray images on the display device and identify any problems, e.g., caries in the patient's teeth.

Caries identification & analysis 220 is adapted to capture a screenshot of information displayed on display device 160. In one example, caries identification & analysis 220 is an independent software application residing and operating on computer 135, separate from and independent of dental image processing & display 210. For example, after dental image processing & display 210 causes display device 160 to show an image containing one or more x-ray images of a patient's teeth, caries identification & analysis 220 may capture a screenshot of the image. A screenshot is a digital representation of an image displayed on a display device. Methods of generating a screenshot are known. A screenshot may include the entire image displayed on a display device or a portion of the displayed image. Caries identification & analysis 220 may store a screenshot image in image library 240. The terms “screenshot” and “screenshot image” are used interchangeably herein.

Caries identification & analysis 220 is also adapted to analyze an image and identify, within the image, one or more x-ray images of a patient's teeth. Referring to FIG. 2, caries identification & analysis 220 includes a machine learning model-1 (222) trained to identify x-ray images within an image.

Machine learning model-1 (222) is trained to identify, classify, infer, and/or predict the locations of individual x-ray images within a digital image. Any suitable machine learning training technique may be used, including, but not limited to, a neural net based algorithm, such as Artificial Neural Network, Deep Learning; a robust linear regression algorithm, such as Random Sample Consensus, Huber Regression, or Theil-Sen Estimator; a kernel based approach like a Support Vector Machine and Kernel Ridge Regression; a tree-based algorithm, such as Classification and Regression Tree, Random Forest, Extra Tree, Gradient Boost Machine, or Alternating Model Tree; Naive Bayes Classifier; and others suitable machine learning algorithms.

In one embodiment, machine learning model-1 (222) is trained with a training sample of hundreds or thousands of images each containing one or more x-ray images. The training data is supplemented by data generated by one or more dental experts who examine the images and identify individual x-ray images within the images. In various embodiments, training data include various types of labels provided by the one or more dental experts whereby the labels are indicative of a type of tooth decay in an x-ray image in the training data reviewed by a dental expert. Each label is paired with a confidence score provided by the dental expert. The confidence score indicates the dental expert's estimation of how likely the paired label correctly identifies a type of tooth decay in a corresponding x-ray image.

Accordingly, machine learning model-1 (222) may from time to time examine a screenshot image and predict the locations of one or more x-ray images in the screenshot image.

Referring to FIG. 2, caries identification & analysis 220 may store any identified x-ray images in image library 240. For purposes of illustration, three x-ray images are shown stored in image library 240, including x-ray image 1 (271), x-ray image 2 (272), and x-ray image 3 (273). More or fewer than three x-ray images may be stored in image library 240. In other embodiments, a representation of an x-ray image (an encoded form of an x-ray image, data indicating a location of an x-ray image, etc.) may be stored in image library 240.

Caries identification & analysis 220 is further adapted to analyze each of the identified x- ray images and identify evidence of caries that is visible in the images. The evidence of caries is identified based on visual information in an image that is associated with a caries. In one embodiment, caries identification & analysis 220 is adapted to identify various types of caries, including, for example, coronal caries, root/cervical caries, recurrent/secondary caries, etc.

Referring again to FIG. 2, caries identification & analysis 220 includes a machine learning model-2 (224) trained to identify, classify, infer, and/or predict evidence of caries in an x-ray image of a patient's teeth. Any suitable machine learning training technique may be used, including, but not limited to, a neural net based algorithm, such as Artificial Neural Network, Deep Learning; a robust linear regression algorithm, such as Random Sample Consensus, Huber Regression, or Theil-Sen Estimator; a kernel based approach like a Support Vector Machine and Kernel Ridge Regression; a tree-based algorithm, such as Classification and Regression Tree, Random Forest, Extra Tree, Gradient Boost Machine, or Alternating Model Tree; Naive Bayes Classifier; and others suitable machine learning algorithms.

In one embodiment, machine learning model-2 (224) is trained with a training sample of hundreds or thousands x-ray images. The training data is supplemented by data generated by one or more dental experts who examine the x-ray images, identify evidence of caries in the x-ray images, and add annotations indicating where the evidence of caries is present. The dental experts also, for each instance of evidence of a caries identified within an x-ray image, specify a confidence score value indicating the dental expert's level of confidence in the diagnosis. The dental expert may further include, for each x-ray showing evidence of a caries, a severity level indicating a severity of the caries.

In one embodiment, machine learning model-2 (224) examines an x-ray image and predicts an instance of a visual characteristic, for example, the location of an instance of a caries, based on visual information the image. For example, machine learning model-2 (224) may predict the location within an x-ray image of evidence of a caries.

In one embodiment, caries identification & analysis 220 is a software application that may be obtained by a dentist and installed on computer 135 separately from dental image processing & display 210. For example, caries identification & analysis 220 may be implemented as a software application that may be accessed via the Internet and downloaded onto computer 135. Caries identification & analysis 220 is adapted to work with any dental image processing software product currently used by dental offices.

Alternatively, caries identification & analysis 220 may be implemented as software and/or circuitry in specially designed hardware installed in or connected to computer 135. For example, caries identification & analysis 220 may be implemented as USB-connected hardware (e.g., a graphics processing unit, or GPU) that may be installed in computer 135.

In another embodiment, caries identification & analysis 220 may be implemented by software integrated into the operating system of computer 135.

In another embodiment, some or all of the functions of caries identification & analysis 220 may be implemented as software accessible to computer 135 via a network. For example, some or all of the functions of caries identification & analysis 220 may be available via the Internet as a service accessible to computer 135. For example, the service may generate a screenshot of an image containing one or more x-ray images and perform analysis of the screenshot, including identifying/predicting locations within the image of one or more x-ray images, identifying/predicting an instance of a caries, etc. The service may also generate one or more masks corresponding to the locations of the caries, and cause the screenshot and the mask(s) to be displayed. Alternatively, computer 135 may generate a screenshot of an image containing one or more x-ray images, and the service may perform analysis of the screenshot.

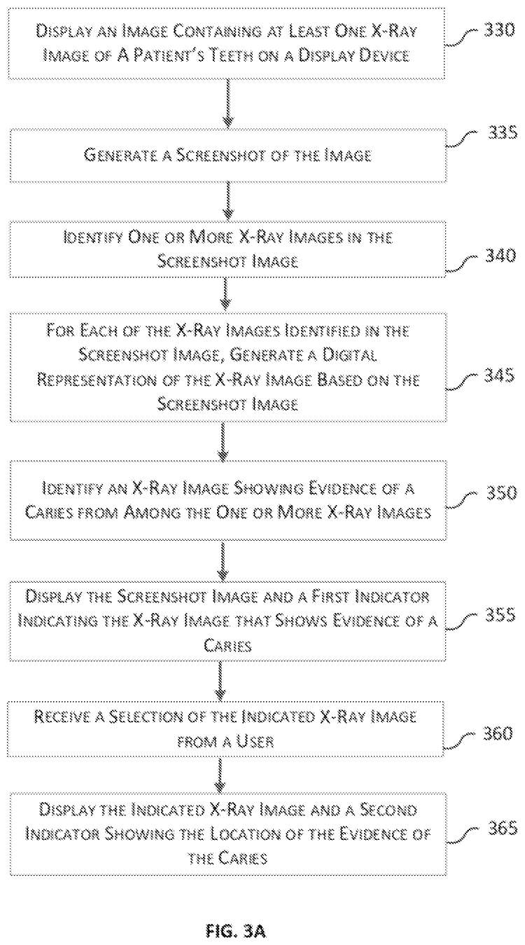

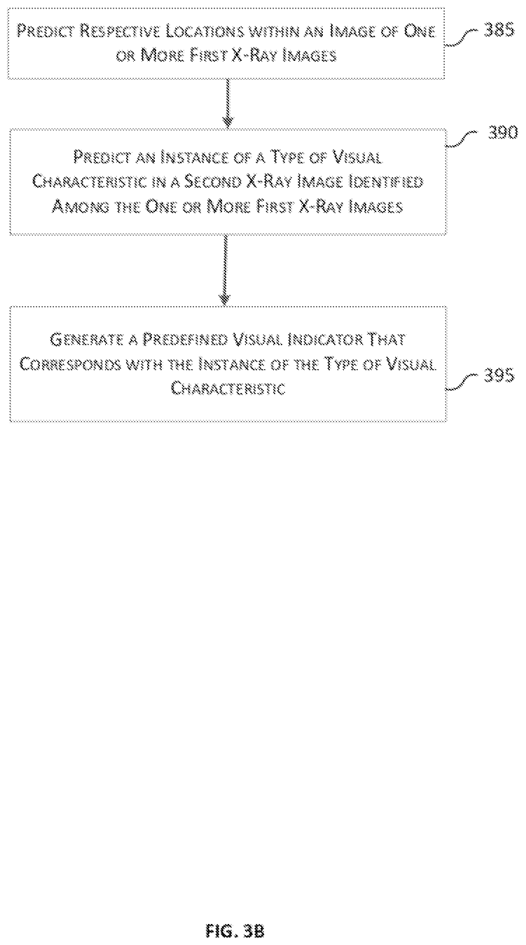

FIG. 3A is a flowchart of a method in accordance with an embodiment. After X-ray imaging device 150 generates one or more x-ray images of a patient's teeth, x-ray imaging device 150 provides the x-ray images to computer 135. Computer 135 causes display device 160 to display the x-ray images to enable a dentist to examine the images. In one embodiment, the x-ray images are displayed together on a display screen, in a well-known manner.

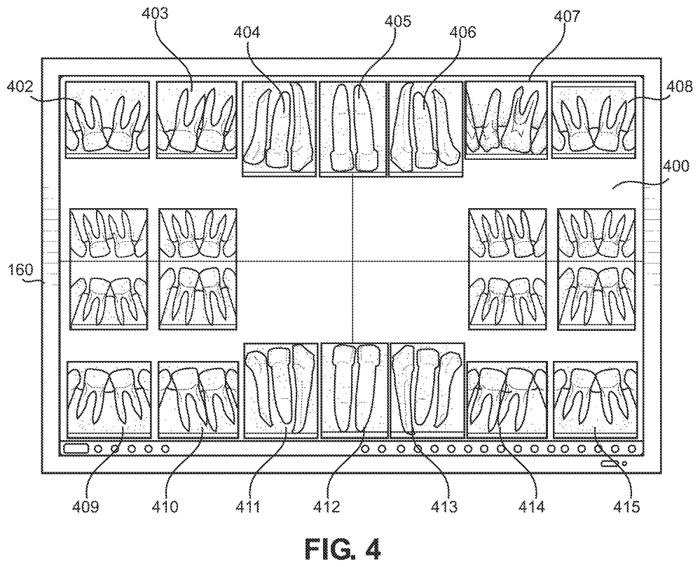

Specifically, at step 330, an image containing at least one x-ray image of a patient's teeth is displayed on a display device. In the illustrative embodiment, dental image & processing & display 210 causes the x-ray images to be displayed on display device 160. FIG. 4 shows display device 160 and an exemplary image displayed thereon in accordance with an embodiment. Using a format commonly used, image 400 includes a plurality of x-ray images of a patient's teeth, including x-ray images 402-408 located along the top edge of the image and x-ray images 409-415 located along the bottom edge of the image.

At step 335, a screenshot of the image is obtained, generating a screenshot image. In the illustrative embodiment, caries identification & analysis 220 generates a screenshot of image 400. The screenshot is a digital representation of image 400. Referring to FIG. 2, the screenshot image is stored in image library 240 as screenshot 265.

At step 340, one or more x-ray images are identified in the screenshot image. Specifically, machine learning model-1 (222) predicts the locations of one or more x-ray images within screenshot 265 based on visual information within the screenshot image that is associated with an x-ray image. In the illustrative embodiment, machine learning model-1 (222) examines screenshot 265 and identifies therein a plurality of x-ray images, including x- ray images 402-408 and 409-415.

At step 345, for each of the one or more x-ray images identified in the screenshot image, a digital representation of the respective x-ray image is generated based on the screenshot image. Caries identification & analysis 220 generates a digital representation of each x-ray image identified in screenshot 265. A digital representation of an x-ray image in a screenshot may include any suitable type of information. For example, a digital representation of an x- ray image may be a digital copy of the x-ray image, an encoded form of the x-ray image, information defining the location of the x-ray image in the screenshot image, or may include other types of information. In the illustrative embodiment, caries identification & analysis 220 generates digital copies of each x-ray image identified in the screenshot. The digital representations of the x-ray images are stored in image library 240.

At step 350, an x-ray image showing evidence of a caries is identified from among the one or more x-ray images. Machine learning model-2 (224) examines x-ray images 402-408 and 409-415 (or the digital representations thereof) to determine if any of the x-ray images show evidence of a caries. Machine learning model-2 (224) identifies evidence of caries in an x-ray image based on visual information within the x-ray image that is associated with evidence of a caries. Evidence of caries may be found in one x-ray image, in a plurality of x- ray images, or in no x-ray images. In the illustrative embodiment, machine learning model-2 (224) identifies evidence of caries in x-ray images 407 and 410.

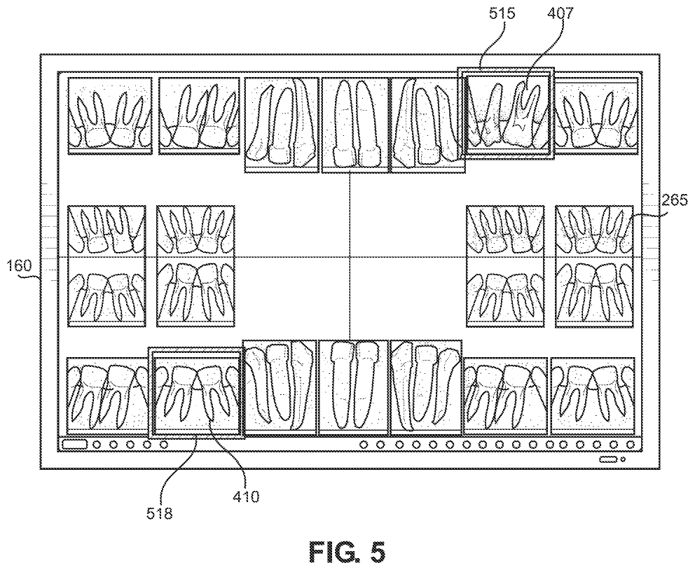

At step 355, the screenshot image and a first indicator indicating the x-ray image that shows evidence of a caries are displayed. Caries identification & analysis 220 causes display device 160 to display screenshot 265 and indicators showing x-ray images 407 and 410. FIG. 5 shows screenshot 265 displayed on display device 160 and two indicators indicating x-ray images 407 and 410 in accordance with an embodiment. Indicator 515 indicates that x- ray image 407 shows evidence of a caries and indicator 518 indicates that x-ray image 410 shows evidence of a caries.

In the illustrative embodiment, indicators 515 and 518 are bounding boxes. In other embodiments, other types of indicators may be used to indicate that a particular x-ray image shows evidence of a caries. For example, other types of indicators that may be used include arrows, regions of color, flashing lights, color patterns, other shapes such as circles, ovals, etc.

At step 360, a selection of the indicated x-ray image is received from a user. Caries identification & analysis 220 provides an option that allows a user to select the indicated x- ray image (or one of the indicated x-ray images) for viewing. In the illustrative embodiment, suppose that the dentist viewing the x-ray images wishes to examine x-ray image 407 in more detail and therefore selects x-ray image 407 (by clicking on x-ray image 407, for example).

At step 365, the indicated x-ray image and a second indicator showing the location of the evidence of the caries are displayed. In one embodiment, caries identification & analysis 220 generates a pre-defined visual indicator corresponding to the instance of the visual characteristic identified in the x-ray image, and displays the x-ray image and the pre-defined visual indicator.

In the illustrative embodiment, in response to the user's selection of the option, caries identification & analysis 220 generates a mask containing an indicator corresponding to the location of the evidence of the caries in x-ray image 407. A mask includes a digital representation of an indicator corresponding to an instance of evidence of a caries within a particular x-ray image. In one embodiment, a mask may contain a single indicator corresponding to a location on a patient's tooth of a single instance of evidence of a caries visible in the x-ray image. If an x-ray image shows evidence of caries in multiple locations, or evidence of different types of caries, then multiple masks corresponding to multiple locations where evidence of a caries is present, or multiple masks corresponding to different types of caries, may be used. For example, a first mask for a first type of caries and a second mask for a second type of caries may be generated. It is understood that the first and second types of caries correspond to different types of caries. Further, pre-defined visual characteristics of the first mask are different than pre-defined visual characteristics of the second mask.

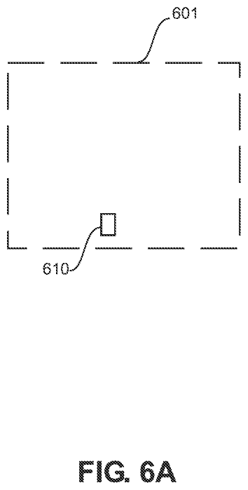

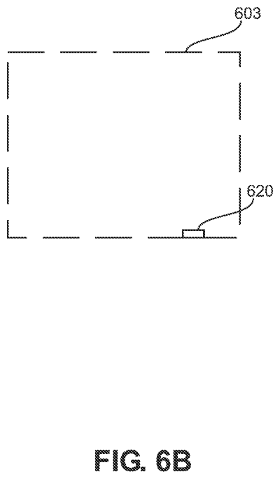

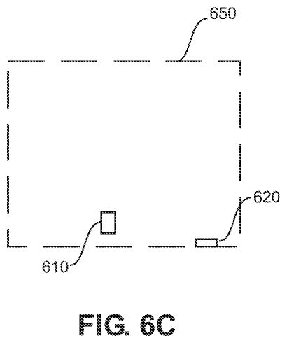

FIG. 6A shows a first mask 601 corresponding to x-ray image 407 in accordance with an embodiment. Indicator 610 corresponds to a first location in x-ray image 407 where evidence of a first caries is present. FIG. 6B shows a second mask 603 corresponding to x-ray image 407 in accordance with an embodiment. Indicator 620 corresponds to a second location in x- ray image 407 where evidence of a second caries is present.

In the illustrative embodiment, first mask 601 is stored in mask library 230 as mask 1 (601). Second mask 603 is stored in mask library 230 as mask 2 (603).

In another embodiment, a single mask may contain multiple indicators corresponding to multiple locations in an x-ray image where evidence of caries is present. For example, FIG. 6C shows a mask in accordance with another embodiment. Mask 650 includes two indicators 610 and 620 each showing a respective location where evidence of a caries is present.

In order to enable a user to view a selected x-ray image and the corresponding indicator(s) simultaneously, caries identification & analysis 220 causes the selected x-ray and the corresponding mask or masks to be displayed on display device 160 simultaneously. For example, the selected x-ray image may be displayed on display device 160 and the corresponding mask or masks may be overlaid on the x-ray image.

In one embodiment, caries identification & analysis 220 provides a user-friendly interface that allows a user to switch between viewing a screenshot image and a selected x-ray alone (without any indicators showing) overlaid over the screenshot image, and viewing the screenshot image with the selected x-ray and the indicators showing. Accordingly, caries identification & analysis 220 may provide a first option that enables a user to view the screenshot image with a selected x-ray image only (without indicators), and a second option that enables the user to view the screenshot image with a selected x-ray image and indicators overlaid over the screenshot image.

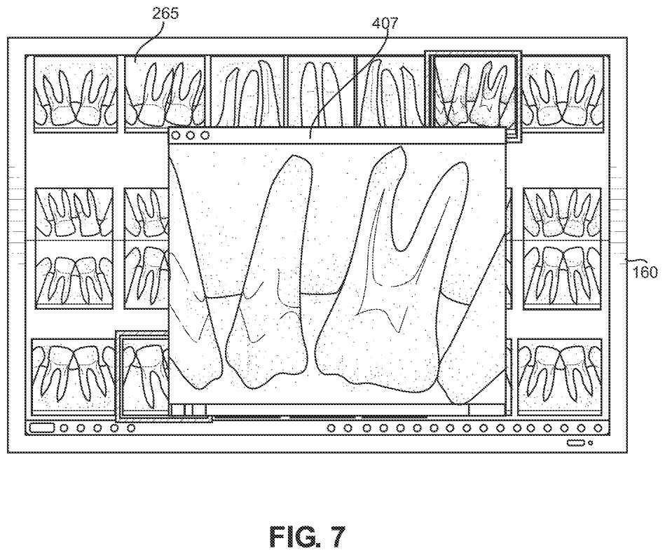

Supposing, in the illustrative embodiment, that the user selects the first option, caries identification & analysis 220 in response causes display device 160 to display screenshot image 265 and x-ray image 407; x-ray image 407 is overlaid over screenshot 265. FIG. 7 shows screenshot 265 and x-ray image 407 displayed on display device 160 simultaneously in accordance with an embodiment. No mask is displayed; therefore no indicators are displayed.

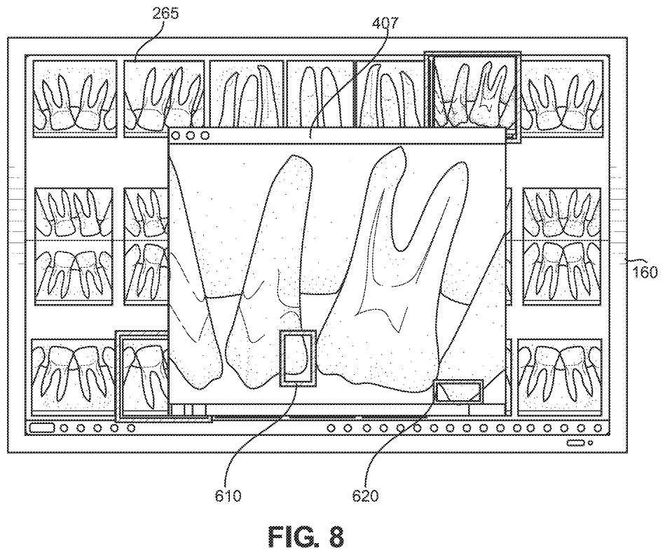

Supposing that the user now selects the second option in order to view the indicators showing the location(s) where evidence of caries is present, caries identification & analysis 220 causes masks 601 and 603 to be displayed on display device 160, overlaid over x-ray image 407. FIG. 8 shows screenshot 265, x-ray image 407, and masks 601 and 603 displayed simultaneously on display device 160 in accordance with an embodiment. X-ray image 407 is overlaid over screenshot 265, and masks 601 and 603 are overlaid over x-ray image 407. Indicator 610 (of mask 601) and indicator 620 (of mask 603) are visible, indicating the locations in x-ray image 407 where evidence of caries is present.

Supposing that the user again wishes to view x-ray image 407 without the indicators, and accordingly selects the first option again, caries identification & analysis 220 removes masks 601 and 603 from the display. In this manner, a user may toggle back and forth between viewing an x-ray image with indicators and viewing the x-ray image without any indicators.

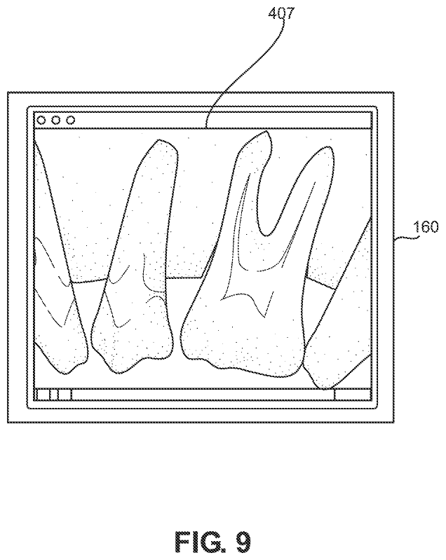

In accordance with another embodiment, caries identification & analysis 220 may also provide a first option that enables the user to view an x-ray image alone (without indicators) and a second option that enables the user to view the x-ray image with the corresponding indicators. Supposing, for example, that a user selects the first option to view x-ray image 407 alone, caries identification & analysis 220 in response causes display device 160 to display x-ray image 407 alone. FIG. 9 shows x-ray image 407 displayed on display device 160 in accordance with an embodiment. No mask is displayed; therefore, no indicators are shown.

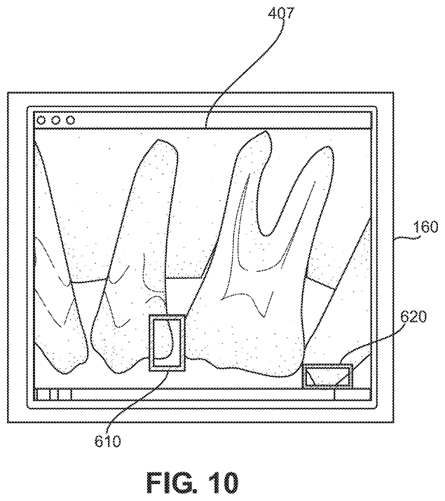

Supposing that the user now selects the second option in order to view x-ray image 407 with the corresponding indicators showing the location(s) where evidence of caries is present, caries identification & analysis 220 in response causes display device 160 to display x-ray image 407 with the corresponding mask or masks overlaid over the x-ray image. FIG. 10 shows x-ray image 407 and masks 601 and 603 displayed simultaneously on display device 160 in accordance with an embodiment. Masks 601 and 603 are overlaid over x-ray image 407. Indicators 610 and 620 are visible, showing the locations where evidence of caries is present.

In the illustrative embodiment, the functionality of caries identification & analysis 220 resides in a first software application operating on computer 135 while the functionality of dental image processing & display 210 resides in a second software application operating on computer 135. The first software application is separate from and independent of the second software application. For example, the administrators of a computer network in a dental office may obtain dental image processing & display 210 as part of a standard suite of software when setting up the computer network. At a subsequent time, caries identification & analysis 220 may be installed or downloaded separately onto one or more computers in the dental office. Caries identification & analysis 220 supplements and augments the functionality of dental image processing & display 210.

Therefore, advantageously, caries identification & analysis 220 improves the functionality of dental image processing & display 210 and therefore improves the functionality of computer 135. Existing dental image processing software applications process and display x-ray images generated by an x-ray imaging device but do not analyze the images to identify where evidence of caries is present. Installing and running caries identification & analysis 220 enables this additional functionality and therefore offers improved functionality for computers and computer networks in existing dental offices.

In another embodiment, the functionality of caries identification & analysis 220 may be combined with the functionality of dental image processing & display 210 in a single integrated software application. Thus, a single software application may receive x-ray images from X-ray image device 150, cause display device 160 to display an image containing the x-ray images, identify an x-ray image that includes evidence of a caries, generate a mask including an indicator showing the location of the evidence of the caries, and cause display device 160 to display the identified x-ray image and the mask simultaneously. The software application may generate a screenshot of the initially displayed image, and analyze the screenshot for evidence of caries, or may analyze the original image to identify evidence of caries.

FIG. 3B is a flowchart of a method in accordance with another embodiment. At step 385, respective locations within an image of one or more first x-ray images are predicted. In the illustrative embodiment, machine learning model-1 (222) predicts locations of x-ray images within an image based on visual information within the image. The image may be a screenshot image or an image generated, for example, by a dental imaging software application.

At step 390, an instance of a type of visual characteristic is predicted in a second x-ray image identified among the one or more first x-ray images. In the illustrative embodiment, machine learning model-2 (224) analyzes the first x-ray images and predicts an instance of evidence of a caries based on visual information in the images.

At step 395, a predefined visual indicator that corresponds with the instance of the type of visual characteristic is generated. Caries identification & analysis 220 generates a mask that includes an indicator indicating the location of the instance of evidence of a caries. In the manner described herein, caries identification & analysis 220 causes display device 160 to display the second x-ray image and the mask. The mask may be overlaid over the second x- ray image.

In other embodiments, systems and methods described herein may be used to examine and identify, and enable an expert to view, possible areas of concern in other types of x-ray images, and in other types of images. For example, systems and methods similar to those described herein may be used to identify areas of concern in x-ray images of other parts of a patient's body, such as a patient's arms, legs, feet, hips, lungs, etc. Systems and methods similar to those described herein may be used to examine and identify areas of concern in a CAT scan of a patient's brain.

In various embodiments, the method steps described herein, including the method steps described in FIG. 3A and/or 3B may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 3A and/or 3B may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand- alone program or as a module, component, subroutine, or other unit suitable for use in a computing environment.

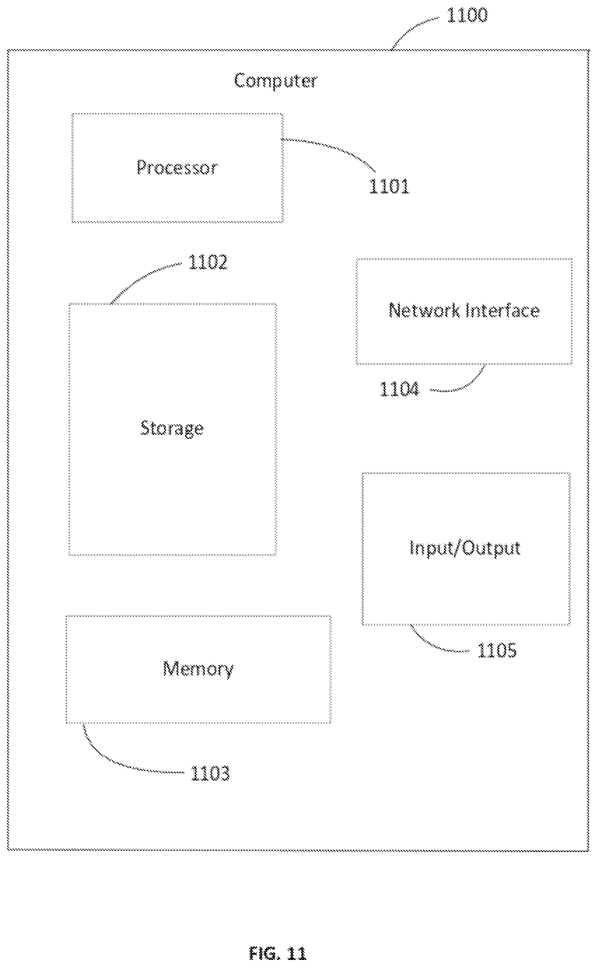

A high-level block diagram of an exemplary computer that may be used to implement systems, apparatus and methods described herein is illustrated in FIG. 11. Computer 1100 includes a processor 1101 operatively coupled to a data storage device 1102 and a memory 1103. Processor 1101 controls the overall operation of computer 1100 by executing computer program instructions that define such operations. The computer program instructions may be stored in data storage device 1102, or other computer readable medium, and loaded into memory 1103 when execution of the computer program instructions is desired. Thus, the method steps of FIG. 3A and/or 3B can be defined by the computer program instructions stored in memory 1103 and/or data storage device 1102 and controlled by the processor 1101 executing the computer program instructions. For example, the computer program instructions can be implemented as computer executable code programmed by one skilled in the art to perform an algorithm defined by the method steps of FIG. 3A and/or 3B. Accordingly, by executing the computer program instructions, the processor 1101 executes an algorithm defined by the method steps of FIG. 3A and/or 3B. Computer 1100 also includes one or more network interfaces 1104 for communicating with other devices via a network. Computer 1100 also includes one or more input/output devices 1105 that enable user interaction with computer 1100 (e.g., display, keyboard, mouse, speakers, buttons, etc.).

Processor 1101 may include both general and special purpose microprocessors, and may be the sole processor or one of multiple processors of computer 1100. Processor 1101 may include one or more central processing units (CPUs), for example. Processor 1101, data storage device 1102, and/or memory 1103 may include, be supplemented by, or incorporated in, one or more application-specific integrated circuits (ASICs) and/or one or more field programmable gate arrays (FPGAs).

Data storage device 1102 and memory 1103 each include a tangible non-transitory computer readable storage medium. Data storage device 1102, and memory 1103, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1105 may include peripherals, such as a printer, scanner, display screen, etc. For example, input/output devices 1105 may include a display device such as a cathode ray tube (CRT) or liquid crystal display (LCD) monitor for displaying information to the user, a keyboard, and a pointing device such as a mouse or a trackball by which the user can provide input to computer 1100.

Any or all of the systems and apparatus discussed herein, including components thereof, may be implemented using a computer such as computer 1100.

One skilled in the art will recognize that an implementation of an actual computer or computer system may have other structures and may contain other components as well, and that FIG. 11 is a high-level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method comprising:
predicting respective locations within an image of one or more first x-ray images;
predicting an instance of a type of visual characteristic in a second x-ray image identified among the one or more first x-ray images; and
generating a pre-defined visual indicator that corresponds with the instance of the type of visual characteristic.

2. The computer-implemented method of claim 1, wherein predicting an instance of a type of visual characteristic in a second x-ray image occurs on a computing device displaying the one or more first x-ray images.

3. The computer-implemented method of claim 2, wherein generating the pre- defined visual indicator comprises:
feeding machine learning input based at least on a portion of a screenshot of the second x-ray image into one or more machine learning models implemented on the computing device displaying the one or more first x-ray images;
receiving, at the computing device, machine learning output; and
generating the pre-defined visual indicator based on the machine learning output.

4. The computer-implemented method of claim 3, wherein the one or more machine learning models are trained according to training data comprising a plurality of human-generated indications of visual characteristics in x-ray images and confidence level scores, wherein a confidence level score represents a confidence of an accuracy of a corresponding human- generated indication.

5. The computer-implemented method of claim 4, wherein the image comprises the one or more first x-ray images, and the image is generated by an independent first software application.

6. The computer-implemented method of claim 5, wherein predicting an instance of a type of visual characteristic in a second x-ray image and generating a pre-defined visual indicator occur separately from the first software application.

7. The computer-implemented method of claim 6, wherein predicting an instance of a type of visual characteristic in a second x-ray image and generating a pre-defined visual indicator further occur while the first software application displays the one or more first x-ray images.

8. The computer-implemented method of claim 7, wherein at least one of the one or more first x-ray images comprises at least an x-ray of at least one tooth.

9. The computer-implemented method of claim 8, wherein the instance of a type of visual characteristic comprises visual evidence of a type of caries.

10. The computer-implemented method of claim 9, further comprising:
in response to predicting the instance of a type of visual characteristic:
generating an indicator overlay based on the pre-defined visual indicator;
generating an overlay image based on the screenshot that includes a least a portion of a display of the second x-ray image, the overlay image including the indicator overlay displayed with respect to a location of the instance of the type of visual characteristic;
wherein the pre-defined visual indicator comprises a mask from a plurality of masks, each respective mask corresponding to a different type of caries, each respective mask in the plurality of masks being different according to a pre-defined visual characteristic.

11. A device comprising:
a memory storing computer program instructions; and
a processor configured to execute the computer program instructions which, when executed on the processor, cause the processor to perform operations comprising:
predicting respective locations within an image of one or more first x-ray images;
predicting an instance of a type of visual characteristic in a second x-ray image identified among the one or more first x-ray images; and
generating a pre-defined visual indicator that corresponds with the instance of the type of visual characteristic.

12. The device of claim 11, wherein predicting an instance of a type of visual characteristic in a second x-ray image occurs while the processor causes a display device to display the one or more first x-ray images.

13. The device of claim 12, wherein generating the pre-defined visual indicator comprises:
feeding machine learning input based at least on a portion of a screenshot of the second x-ray image into one or more machine learning models implemented on the device;
receiving, at the device, machine learning output; and
generating the pre-defined visual indicator based on the machine learning output.

14. The device of claim 13, wherein the one or more machine learning models are trained according to training data comprising a plurality of human-generated indications of visual characteristics in x-ray images and confidence level scores each representing a level of confidence in a corresponding human-generated indication.

15. The device of claim 14, wherein the image comprises the one or more first x-ray images, and the image is generated by an independent first software application.

16. The device of claim 15, wherein predicting an instance of a type of visual characteristic in a second x-ray image and generating a pre-defined visual indicator occur separately from the first software application.

17. The device of claim 16, wherein predicting an instance of a type of visual characteristic in a second x-ray image and generating a pre-defined visual indicator further occur while the first software application causes the display device to display the one or more first x- ray images.

18. The device of claim 17, wherein at least one of the one or more first x-ray images comprises at least an x-ray of at least one tooth.

19. The device method of claim 18, wherein the instance of a type of visual characteristic comprises visual evidence of a type of caries.

20. The device of claim 19, wherein the operations further comprise:
in response to predicting the instance of a type of visual characteristic:
generating an indicator overlay based on the pre-defined visual indicator; and
generating an overlay image based on the screenshot that includes a least a portion of a display of the second x-ray image, the overlay image including the indicator overlay displayed with respect to a location of the instance of the type of visual characteristic.
